(19) United States
(12) Patent Application Publication
(10) Pub. No.: US 2008/0061621 A1
(43) Pub. Date: Mar. 13, 2008

(54) Flexible tubing for a rotary-percussion drilling device

(75) Inventors: Franck Leon, Lyon (FR); Frederic Brongniart, Liergues (FR)

Correspondence Address: OLIFF & BERRIDGE, PLC, P.O. BOX 320850, ALEXANDRIA, VA, 22320-4850, US

(73) Assignee: SANDVIK MINING AND CONSTRUCTION LYON SAS, MEYZIEU (FR)

(21) Appl. No.: 11/889,569

(22) Filed: Aug. 14, 2007

(30) Foreign Application Priority Data
Sep. 13, 2006 (FR) 06.07997

(51) Int. Cl. E21C 25/00; F16L 11/00

(52) U.S. Cl. 299/75; 138/123

(57) ABSTRACT

The flexible tubing (2) is designed to transmit a thrust and a rotary torque to a drill body and to supply the drill body with pressurized hydraulic fluid.

This flexible tubing (2) is externally or internally composed of a hydraulic hose (3) and, internally or externally depending on the case, a stapled tube (4). It comprises, at its ends, fittings (6) suitable for transmitting the thrust and the rotary torque.

Application to rotary-percussion drilling devices using a “downhole hammer” for mining work.

The present invention relates to drilling materials used during underground work in particular in mining operations. It relates in particular to devices for rotary-percussion drilling, of the type known as “downhole hammer”, used in low-height mine galleries, particularly for drilling holes in the “roof” of such galleries.

Yet more particularly, this invention relates to a flexible tubing, used to supply high-pressure hydraulic fluid such as water to a downhole hammer as described, for example, in patent documents EP 0 394 255 BE1, EP 0 534 806 BE1, and EP 0 733 15.2 B1. Such a downhole hammer comprises a generally cylinder-shaped drill body that is connected, via the flexible tubing, to a high-pressure water pump, placed at a distance particularly on a low-height carrying vehicle.

Means for moving the flexible tubing forwards are provided on the carrying vehicle, to transmit, by means of this flexible tubing, a thrust to the drill body, the depth of the hole drilled being substantially equivalent to the drive travel of the flexible tubing. In addition, means of rotating the flexible tubing are provided on the carrying vehicle, to transmit, by means of this tubing, an alternating or continuous rotary movement to the drill body.

Therefore, the flexible tubing here must simultaneously transmit the thrust (that may be greater than 2000 N) and the rotary torque (of the order of 50 to 200 Nm) to the drill body, and carry a pressurized hydraulic fluid. Currently there exists no flexible device that can satisfactorily perform these three functions, and is therefore suitable for the application concerned here. In particular, if a conventional hydraulic hose is used whose end fittings are swaged onto a rubber tube, this hose would not withstand a considerable rotary torque.

The object of the present invention is to help to bridge this gap, and its object therefore is to provide a flexible device of special design making it possible to transmit a thrust and a rotary torque, while carrying the pressurized hydraulic fluid necessary to operate the downhole hammer, this device still being composed of relatively common parts and materials so as to be able to be manufactured economically and also be easily replaced after wear or damage.

Accordingly, the subject of the invention is a flexible tubing for a rotary-percussion drilling device, the flexible tubing being designed to transmit a thrust and a rotary torque to a drill body and to supply the drill body with pressurized hydraulic fluid, this flexible tubing being essentially characterized in that it is externally or internally composed of a hydraulic hose and, internally or externally depending on the case, a stapled tube or a contiguous coil spring, the ends of the flexible tubing being provided with fittings suitable for transmitting the thrust and the rotary torque.

In this flexible tubing, the external (or internal) hydraulic hose provides the seal and the pressure-resistance necessary to carry the hydraulic fluid, particularly high-pressure water, that is carried to the downhole hammer to perform the percussion function. This external (or internal) hydraulic hose advantageously has a conventional structure incorporating one, two or more braids.

The internal (or external) stapled tube provides the flexible tubing with the rigidity necessary to transmit the thrust and the rotary torque used for drilling.

The fittings, situated at the ends of the flexible tubing, are necessary for fitting this flexible tubing to the motorized rotation means on the one hand, and to the downhole hammer on the other hand. In order to transmit the thrust and the rotary torque through the fittings, a rigid connection is provided between a portion of each fitting and the corresponding end of the stapled tube or of the contiguous coil spring.

In a preferred embodiment of the flexible tubing that is the subject of the invention, each fitting comprises an external annular fitting end-piece, a cylindrical insert engaged inside the stapled tube or the contiguous coil spring, itself internal, and an external skirt fitted around the end of the hydraulic hose, external in this case.

In any case, the invention will be better understood with the aid of the following description, with reference to the appended schematic drawing representing, as an example, a form of execution of this flexible tubing for a rotary-percussion drilling device:

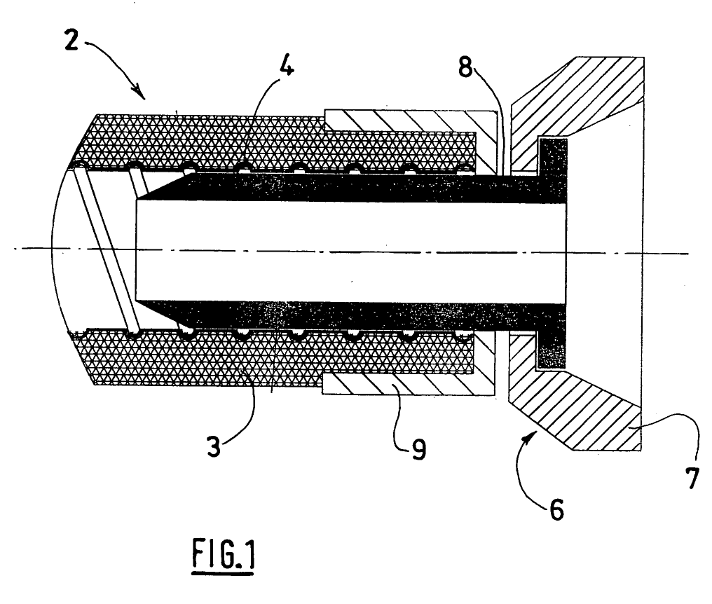

FIG. 1 is a partial view of a flexible tubing according to the present invention, seen in section passing through its axis;

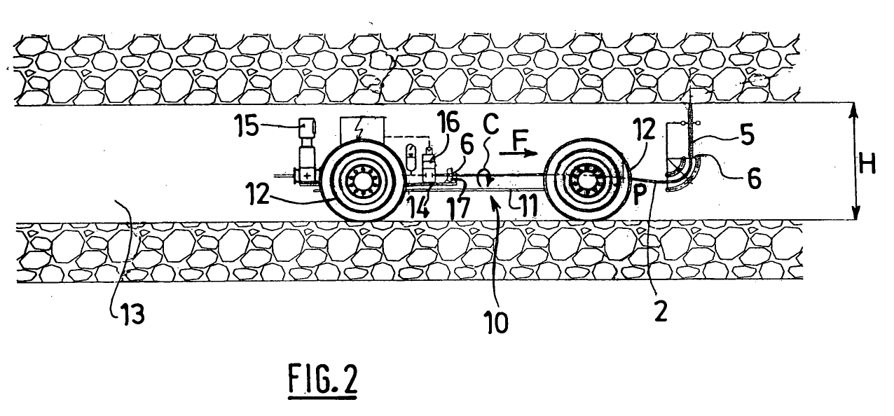

FIG. 2 illustrates a use of this flexible tubing on a rotary-percussion drilling device.

FIG. 1 represents a section of a flexible tubing indicated in its entirety by reference number 2, this figure more particularly showing the region of one end of this flexible tubing 2.

In its running portion, the flexible tubing 2 has a diameter of less than 30 mm, and it consists here of a conventional hydraulic hose 3 on the outside, and of a tube 4 of the stapled type on the inside. The hydraulic hose 3, that may have two, three or four braids, provides the seal and the pressure-resistance necessary to carry the hydraulic fluid, such as high-pressure water, that in this case supplies a downhole hammer 5 (see FIG. 2).

The stapled tube 4 provides the flexible tubing 2 with the rigidity necessary to transmit the thrust and the rotary torque to the downhole hammer 5.

At both ends of the flexible tubing 2 fittings 6, of which one is visible in FIG. 1, are provided. Each fitting 6 comprises an external annular fitting end-piece 7, a cylindrical insert 8 engaged inside the stapled tube 4, and an external skirt 9 fitted around the end of the hydraulic hose 3. The fitting 6 thus constituted has a rigid connection with the stapled tube 4 which allows the thrust and the rotary torque to be transmitted via this fitting 6, particularly for transmitting this thrust and this torque to the downhole hammer 5.

FIG. 2 illustrates, very schematically and as an example, a rotary-percussion drilling device using the flexible tubing 2 described above. This drilling device comprises a carrying vehicle 10, having a chassis 11 and wheels 12 that allow it to move in a mine gallery 13 that may be of low height H. On the chassis 11 of the vehicle 10 a mobile platform 14 is mounted that can be moved in translation lengthwise on the chassis 11. The mobile platform 14 carries a high-pressure water pump 15 that is connected, via the flexible tubing 2, to the downhole hammer 5 which, during use, is brought to the location of the hole to be drilled, particularly in the “roof” of the mine gallery 13.

At the point of departure of the flexible tubing 2 are provided an electrovalve 16 allowing water to travel at high pressure to the tubing 2 and motorized means 17 for rotating the flexible tubing 2.

In the present case, the first fitting 6 of the flexible tubing 2 is fitted to the motorized means 17 for rotating this flexible tubing 2. The second fitting 6 of the flexible tubing 2 is fitted to the rear end of the drill body belonging to the downhole hammer 5. Therefore, the flexible tubing 2, with its fittings 6, provides the transmission to the downhole hammer 5:
of the thrust F exerted by the motorized movement in translation of the mobile platform 14; and
of the rotary torque C imparted by the motorized means 17.

As it goes without saying, the invention is not limited to the single form of execution of this flexible tubing for a rotary-percussion drilling device that has been described above as an example; on the contrary, it embraces all the variant embodiments and applications thereof respecting the same principle.

It is thus in particular that there would be no departure from the context of the invention:
by an inversion of disposition in the structure of the flexible tube, the hydraulic hose occupying in this case an internal position (and no longer external) and the stapled tube then occupying an external position (and no longer internal);
by changes of detail, concerning for example the constitution of the fittings of the flexible tubing, in particular its end-pieces that may be of any type;
by the use of any equivalent components, in particular by replacing the stapled tube inside the flexible tubing with an internal contiguous coil spring whose design would also make it possible to transmit the thrust and the rotary torque;
by adapting this flexible tubing to rotary-percussion drilling devices of various types, as concerns both the downhole hammer and the system of supplying pressurized fluid and forward travel, the platform that is mobile in translation in particular being replaceable by a reel mounted on the carrying vehicle and causing the flexible tubing to travel forwards;
finally, in a similar kind of idea, by replacing the mobile platform with a conventional drilling slide, in which case the assembly formed by the rotation means, the flexible tubing and the downhole hammer may be moved by the slide.

1. Flexible tubing for a rotary-percussion drilling device, the flexible tubing being designed to transmit a thrust and a rotary torque to a drill body and to supply the drill body with pressurized hydraulic fluid, wherein the flexible tubing is externally or internally composed of a hydraulic hose and, internally or externally depending on the case, a stapled tube or a contiguous coil spring, the ends of the flexible tubing being provided with fittings suitable for transmitting the thrust and the rotary torque.

2. The flexible tubing according to claim 1, wherein the external or internal hydraulic hose having a structure incorporating one, two or more braids.

3. The flexible tubing according to claim 1, wherein a rigid connection is provided between a portion of each fitting and the corresponding end of the stapled tube or of the contiguous coil spring.

4. The flexible tubing according to claim 3, wherein each fitting comprises an external fitting end-piece, a cylindrical insert engaged inside the stapled tube or the contiguous coil spring, itself internal, and an external skirt fitted around the end of the hydraulic hose, external in this case.

5. A rotary-percussion drilling device, comprising:
the flexible tubing according to claim 1;
a drill body connected by the flexible tubing to a high-pressure water pump; and
motorized means for rotating the flexible tubing.

6. The flexible tubing according to claim 2, wherein a rigid connection is provided between a portion of each fitting and the corresponding end of the stapled tube or of the contiguous coil spring.

7. The flexible tubing according to claim 6, wherein each fitting comprises an external fitting end-piece, a cylindrical insert engaged inside the stapled tube or the contiguous coil spring, itself internal, and an external skirt fitted around the end of the hydraulic hose, external in this case.

8. A rotary-percussion drilling device, comprising:
the flexible tubing according to claim 2;
a drill body connected by the flexible tubing to a high-pressure water pump; and
motorized means for rotating the flexible tubing.

9. A rotary-percussion drilling device, comprising:
the flexible tubing according to claim 3;
a drill body connected by the flexible tubing to a high-pressure water pump; and
motorized means for rotating the flexible tubing.

10. A rotary-percussion drilling device, comprising:
the flexible tubing according to claim 4;
a drill body connected by the flexible tubing to a high-pressure water pump; and
motorized means for rotating the flexible tubing.

11. A rotary-percussion drilling device, comprising:
the flexible tubing according to claim 6;
a drill body connected by the flexible tubing to a high-pressure water pump; and
motorized means for rotating the flexible tubing.

12. A rotary-percussion drilling device, comprising:
the flexible tubing according to claim 7;
a drill body connected by the flexible tubing to a high-pressure water pump; and
motorized means for rotating the flexible tubing.
the fixed reproduction order of said one part of the cells designated by the original program chain information being different from the reproduction order of the other part of the cells designated by the user-defined program chain information,
the original program chain information designating an original program chain and including program chain general information for the original program chain and one or more pieces of program information designating one or more programs being included in the original program chain,
the program chain general information for the original program chain containing a total number of programs,
a maximum number of the programs in the original program chain being 99,
the user-defined program chain information designating a user-defined program chain and including general information for user-defined program chain, and
the program chain general information for the user-defined program chain having a total number of programs in the user-defined program chain being set to 0,
wherein the management information provides a functionality with respect to the video data such that when processed by the information recording/reproducing apparatus, and
the information objects are managed and accessed according to the management information.
